(19) United States
(12) Patent Application Publication
(10) Pub. No.: US 2003/0183658 A1
(43) Pub. Date: Oct. 2, 2003

(54) Hair removal cream dispenser

(76) Inventors: Cary Michael Sartin, New York, NY (US); Scott Michael Croce, East Brunswick, NJ (US)

Correspondence Address: KENYON & KENYON, 1500 K STREET, N.W., SUITE 700, WASHINGTON, DC, 20005, US

(21) Appl. No.: 10/108,873

(22) Filed: Mar. 29, 2002

(51) Int. Cl. B67D 5/42

(52) U.S. Cl. 222/390

(57) ABSTRACT

A dispenser includes hair removal cream and a housing defining a reservoir, where the reservoir contains the hair removal cream. A stationary application member is coupled to the housing. The stationary application member has an external application surface and outlet walls defining one or more application apertures. The application apertures permit a controllable amount of the hair removal cream to exit the reservoir and contact the external application surface during application. By providing a stationary application member, the hair removal cream can be applied directly to the body part of interest and performance issues related to rotatable application members are avoided.

### BACKGROUND

1. Technical Field

Embodiments of the present invention generally relate to hair removal systems. More particularly, embodiments relate to an improved hair removal cream dispenser.

2. Discussion

The removal of unwanted human hair has long been a matter of concern, and over the years a number of hair removal (or depilatory) systems have been developed. For example, depilatory waxes have been used to remove hair from the legs, arms, underarms, bikini area and face. While waxing is generally considered to be effective as a temporary solution, it is well known to be a relatively painful process. Other more permanent solutions, such as electrolysis, are also known to cause discomfort.

In response to these challenges, depilatory creams, which allow hair to be removed with significantly less discomfort, have entered the market with substantial success. While the chemical formulations of depilatory creams continue to improve, a number of difficulties remain.

A particular difficulty relates to the application of the depilatory cream to the body. One conventional hair removal dispenser provides a tube with resilient side walls and a large opening at one end. By squeezing the tube, the user can apply the hair removal cream to the user's fingers, and then apply the cream to the area of interest. It is easy to understand that this approach can be undesirably messy and is impractical when applying the cream to large areas such as the legs and/or arms. Pump configurations have also been developed that suffer from the same drawbacks.

Other approaches to the dispensing of hair removal creams involve a roller (or rotary) configuration such as the device shown in U.S. Pat. No. 4,752,148 to Mann. In this configuration the housing of the dispenser defines a reservoir for storing a depilatory. The housing further includes a dispensing head and a dispensing opening for permitting the depilatory to flow from the reservoir to the dispensing head. A rotary application member (or roller) having raised radially disposed and spaced apart ribs, is disposed in the dispensing head for rolling the depilatory to a human's skin when the depilatory flows from the reservoir through the dispensing opening onto the roller.

While the roller approach can be useful when applying the hair removal cream to large body parts, considerable room for improvement remains. For example, it has been determined that the moving parts of the roller assembly often become clogged with the cream after use. Furthermore, this approach typically lacks a sealing mechanism to keep the cream from drying out between uses. It has also been shown that the rotary application member does not work well in tight facial areas, such as above the lip, on the chin and on the cheeks. There is, therefore, a need to provide a hair removal cream dispenser having an application member that enables the depilatory to be applied directly to the area of interest, where the application member is not subject to the problems associated with conventional configurations.

### BRIEF DESCRIPTION OF THE DRAWINGS

The various advantages of the present invention will become apparent to one skilled in the art by reading the following specification and appended claims, and by referencing the following drawings, in which:

FIG. 1 is a side view of an example of a hair removal dispenser in accordance with one embodiment of the invention;

FIG. 2 is a perspective view of the dispenser shown in FIG. 1 with the cap removed in accordance with one embodiment of the invention;

FIG. 3 is an exploded view of example of a hair removal cream dispenser during actuation in accordance with one embodiment of the invention;

FIG. 4 is a top view in the direction of arrows 4-4 shown in FIG. 3 in accordance with one embodiment of the invention;

FIG. 5 is a bottom view in the direction of lines 5-5 shown in FIG. 3 in accordance with one embodiment of the invention;

FIG. 6 is a side view of an example of a hair removal cream dispenser in accordance with an alternative embodiment of the invention;

FIG. 7 is a sectional view of the dispenser shown in FIG. 6 in accordance with an alternative embodiment of the invention; and

FIG. 8 is a top view of the dispenser shown in FIG. 6 with the cap removed in accordance with an alternative embodiment of the invention.

### DETAILED DESCRIPTION

Embodiments of the present invention provide a system and method of dispensing hair removal cream in a unique and beneficial manner. In one embodiment, a dispenser includes hair removal cream and a housing defining a reservoir. The reservoir contains the hair removal cream. The dispenser further includes a stationary application member coupled to the housing. The stationary application member has an external application surface and outlet walls defining an application aperture. The application aperture permits a controllable amount of the hair removal cream to exit the reservoir and contact the external application surface during application. By providing a stationary application member, the cream may be applied directly to the body area of interest, and the above-described clogging concerns are obviated. Furthermore, the stationary application member can be readily sized to match the desired type of body part.

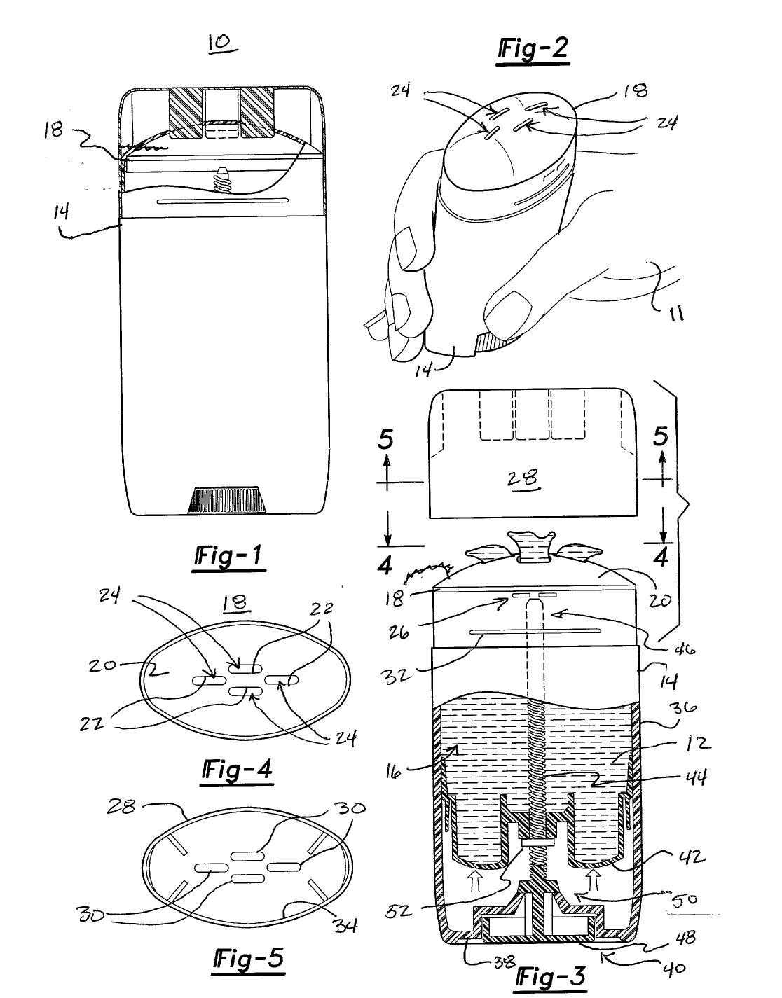

Turning now to FIGS. 1-5, a dispenser 10 is shown in accordance with one embodiment of the invention. Generally, dispenser 10 includes hair removal cream 12 and a housing 14 defining a reservoir 16. The reservoir 16 contains the hair removal cream 12. A stationary application member 18 is coupled to the housing 14, where the stationary application member 18 has an external application surface 20 and outlet walls 22 defining one or more application apertures 24. It can be seen that the application apertures 24 permit the hair removal cream 12 to exit the reservoir 16 and contact the external application surface 20 during application by a user 11.

It can further be seen that the external application surface 20 has a convex shape that significantly facilitates the hair removal application process. For example, as the cream 12 exits the application apertures 24, the application member 18 can be gently moved across the skin of the user. It will further be appreciated that since the application member 18 is stationary, clogging and other difficulties with moving parts are no longer an issue. Notwithstanding, the application member 18 can be removably coupled to the housing 14 by providing a mating rib/slot configuration 26. In such case, the dispenser can be refilled as necessary.

It will further be appreciated that although the outlet walls 22 of the illustrated application member 18 define four application apertures 22, any number of application apertures may be used depending upon the circumstances. For example, a design tradeoff between the number (or count) of application apertures 24 and the size of the application apertures 24 can be made. Thus, it may be desirable to increase size while decreasing count. In this regard, it will be appreciated that increasing the number of application apertures 24 insures better coverage of the external application surface 20 during application of the cream 12 to the skin. Furthermore, the application apertures 24 are not limited to the oval shape illustrated. For example, circular, rectangular and square shapes are all possible.

As best shown in FIGS. 3 and 5, the dispenser 10 further includes a cap 28 to removably seal the application apertures 24. The cap 28 has a unique structure to keep the hair removal cream from drying out between uses. For example, the cap 28 has a plurality of alignment members 30 corresponding to the plurality of application apertures 24. The alignment members 30 provide additional sealing functionality to the cap 28 by pushing the hair removal cream back into the reservoir and individually closing off each application aperture 24. As such, each alignment member 30 has an oval cross-section, which corresponds to the oval shape of the application apertures 24. As in the case of the application apertures 24, the alignment members 30 may have a wide variety of shapes. A mating ridge 32 is provided on the exterior surface of the housing 14 to provide a stabilizing force against the interior surface 34 of the cap 18.

It can further be seen that the housing 14 also includes rigid side walls 36 and a rigid bottom wall 38 coupled to the side walls 36. The side walls 36 and the bottom wall 38 define the reservoir 16. In the illustrated embodiment, an actuator 40 is coupled to the bottom wall 38, where the actuator selectively forces the hair removal cream 12 through the application apertures 24. Specifically, the actuator 40 includes a pressure member 42 disposed within the reservoir 16 and a longitudinal member 44. The longitudinal member 44 has a first end 46 extending through the bottom wall 38 into the reservoir 16, and the longitudinal member 44 is coupled to the pressure member 42. A dial 48 is coupled to a second end 50 of the longitudinal member 44. It can be seen that the pressure member 42 is adjacent to a disk 52, which mates with threads of the longitudinal member 44 such that rotation of the dial 48 causes the pressure member 42 to move longitudinally.

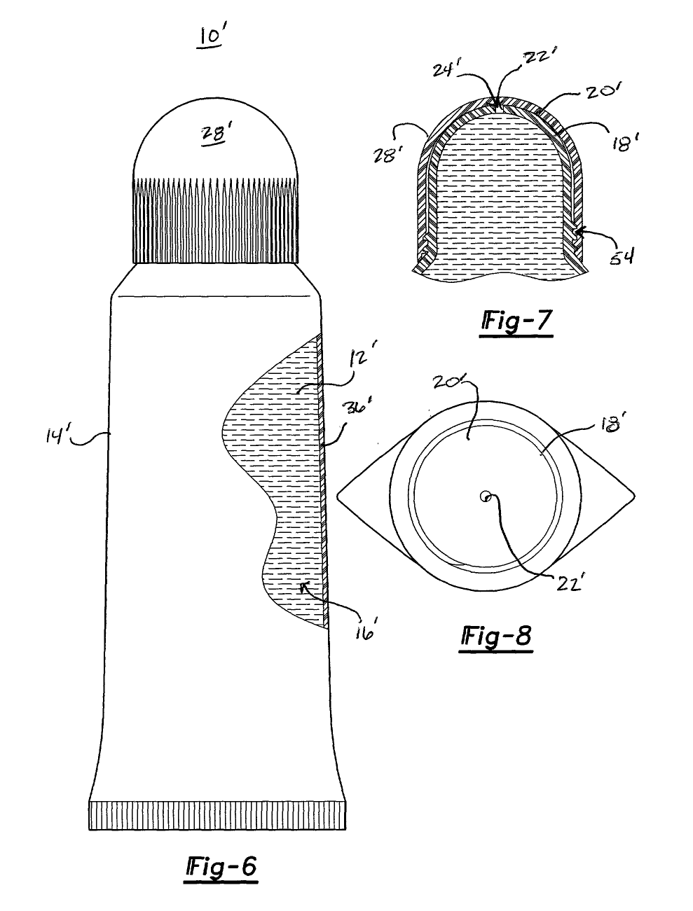

It will be appreciated that the above-described application member 18 has a major axis of approximately 3 inches (7.62 cm) and a minor axis of approximately 1.5 inches (3.81 cm), and is therefore sized to facilitate application of the hair removal cream 12 to a non-facial body part such as the legs, arms, etc. FIGS. 6-8 demonstrate an alternative approach in which a dispenser 10′ has a stationary application member that is sized to facilitate application of the hair removal cream 12′ to a facial body part such as the upper lip, chin and cheeks. It can generally be seen that the dispenser 10′ includes a housing 14′ and a stationary application member 18′. The housing 14′ defines a reservoir 16′, where the reservoir 16′ contains the hair removal cream 12′. The stationary application member 18′ is coupled to the housing 14′ and has an external application surface 20 and outlet walls 22′ defining an application aperture 24′. As already discussed, the application aperture 24′ permits the hair removal cream 12′ to exit the reservoir 16′ and contact the external application surface 20′ during the application. It can be seen that a cap 28′ removably seals the application aperture 24′, where the housing 14′ and the cap 28′ have mating threads 54. It will further be appreciated that in this embodiment the application member 18′ is fixedly coupled to the housing 14′ and the assembly may be molded as one integral unit. Furthermore, the housing 14′ includes resilient side walls 36′ as opposed to the rigid side walls 36 of dispenser 10 (FIG. 3). The cream 12′ is therefore forced through the application aperture by squeezing the resilient side walls 36′.

The cream is able to flow through the application apertures and may have any composition suitable for hair removal. For example, the cream 12 of the dispenser 10 may include smoothing ingredients to facilitate application, as well as moisturizing and antioxidant ingredients. In one approach the hair removal cream 12 includes purified water (aqua), aloe vera, mineral oil, calcium, thioglycolate, cetearyl, alcohol, ceteareth-20, calcium hydroxide, sodium hydroxide, allantoin, tocopheryl acetate, bisabolol, beta glucan and fragrance. The cream 12′ used in dispenser 10′ may also include smoothing and moisturizing ingredients, and in one embodiment has a composition of purified water (aqua), aloe vera, mineral oil, calcium thioglycolate, cetearyl alcohol, ceteareth-20, calcium hydroxide, sodium hydroxide, allantoin, beta glucan, bisabolol and fragrance.

Those skilled in the art can now appreciate from the foregoing description that the broad techniques of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

What is claimed is:

1. A dispenser comprising:
hair removal cream;
a housing defining a reservoir, the reservoir containing the hair removal cream; and
a stationary application member coupled to the housing, the stationary application member having an external application surface and outlet walls defining an application aperture, the application aperture permitting a controllable amount of the hair removal cream to exit the reservoir and contact the external application surface during application.

2. The dispenser of claim 1 wherein the external application surface has a convex shape.

3. The dispenser of claim 1 wherein the outlet walls of the application member define a plurality of application apertures.

4. The dispenser of claim 3 wherein the outlet walls define an oval shape for each application aperture.

5. The dispenser of claim 3 further including a cap to removably seal the plurality of application apertures, the cap having a plurality of alignment members corresponding to the plurality of application apertures.

6. The dispenser of claim 5 wherein each alignment member has an oval cross-section.

7. The dispenser of claim 1 further including a cap to removably seal the application aperture.

8. The dispenser of claim 7 wherein the housing and the cap have mating threads.

9. The dispenser of claim 1 wherein the application member is removably coupled to the housing.

10. The dispenser of claim 1 wherein the application member is fixedly coupled to the housing.

11. The dispenser of claim 1 wherein the housing includes:
rigid side walls;
a rigid bottom wall coupled to the side walls, the side walls and the bottom wall defining the reservoir; and
an actuator coupled to the bottom wall, the actuator to selectively force controllable amount of the hair removal cream through the application aperture.

12. The dispenser of claim 11 wherein the actuator includes:
a pressure member disposed within the reservoir;
a longitudinal member having a first end extending through the bottom wall, the longitudinal member being coupled to the pressure member; and
a dial coupled to a second end of the longitudinal member.

13. The dispenser of claim 12 wherein the pressure member is adjacent to a disc which mates with threads of the longitudinal member such that rotation of the dial causes disc and the pressure member to move longitudinally.

14. The dispenser of claim 1 wherein the housing includes resilient side walls.

15. A dispenser comprising:
hair removal cream;
rigid side walls;
a rigid bottom wall coupled to the side walls, the side walls and the bottom wall defining a reservoir, the reservoir containing the hair removal cream;
a pressure member disposed within the reservoir;
a longitudinal member having a first end extending through the bottom wall, the longitudinal member being coupled to the pressure member;
a dial coupled to a second end of the longitudinal member, the pressure member being adjacent to a disc which mates with threads of the longitudinal member such that rotation of the dial causes the disc and the pressure member to move longitudinally;
a stationary application member coupled to the side walls, the stationary application member having a convex external application surface and outlet walls defining a plurality of application apertures, the application apertures permitting a controllable amount of the hair removal cream to exit the reservoir and contact the external application surface if rotation of the dial causes the pressure member to move in a first longitudinal direction.

16. The dispenser of claim 15 further including a cap to removably seal the plurality of application apertures, the cap having a plurality of alignment members corresponding to the plurality of application apertures.

17. The dispenser of claim 16 wherein each alignment member has an oval cross-section.

18. The dispenser of claim 15 wherein the outlet walls define an oval shape for each application aperture.

19. The dispenser of claim 15 wherein the application member is removably coupled to the housing.

20. The dispenser of claim 15 wherein the application member is sized to facilitate application of the hair removal cream to a non-facial body part.
